(19) United States
(12) Patent Application Publication
(10) Pub. No.: US 2009/0120511 A1
(43) Pub. Date: May 14, 2009

(54) STANDPIPE DIRECT FLOAT VALVE

(75) Inventor: Zvi Weingarten, Evron (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: BERMAD CS LTD., Kibbutz Evron (IL)

(21) Appl. No.: 11/938,800

(22) Filed: Nov. 13, 2007

(51) Int. Cl. F16K 31/18; F17D 3/00

(52) U.S. Cl. 137/426; 137/2

(57) ABSTRACT

The standpipe direct float valve of the present invention is configured such that the valve plug is directly connected to the float element and both the valve plug and the float element are deployed within the standpipe housing. The standpipe housing has an inlet port and at least one outlet port. The valve plug is configured to regulate the fluid level, commonly referred to in the art as head, in the standpipe housing by controlling the flow of fluid through the inlet port and into the standpipe housing. The valve plug is deployed within the standpipe housing and is directly connected to, and actuated by, a float element that is deployed within the standpipe housing and reactive to the fluid level in the standpipe housing. Preferably, the valve plug and the float element are integrally formed. So configure, the standpipe float valve of the present invention provides a method for maintaining a substantially constant flow pressure through an outlet port of a standpipe float valve having a standpipe housing configured with an inlet port and an outlet port. This is accomplished by maintaining a substantially constant fluid level into the standpipe housing by displacement of the float element in response to the fluid level in the standpipe housing so as to actuate the valve plug between an open position, in which fluid flows through the inlet port into the standpipe housing and a closed position in which fluid flow through the inlet port is blocked. A full range of fluid flow through the inlet port and into the standpipe housing is possible due to the fill range of movement of the valve plug between filly closed and fully open is possible.

### FIELD AND BACKGROUND OF THE INVENTION

The present invention relates to standpipe float valves and, in particular, it concerns a standpipe float valve in which the float mechanism directly actuates a valve plug that is deployed within the standpipe.

It is known to provide water systems having a standpipe to ensure that the system pressure does not exceed the design pressure for the piping within the system.

The standpipe typically is located upstream of the irrigation system on a ‘T’ off the main supply pipe. Should the pressure of the water entering the standpipe rise above the design value, the water level in the standpipe will rise and overflow the standpipe, spilling out of the open top of the standpipe, thereby protecting the system from damage.

Presently the standpipe is associated with an automatic hydraulic float control valves installed upstream to the standpipe. The float valve maintains a constant water level in the standpipe thereby regulating the standpipe inflow to match the outflow system's demand. These automatic control valves are configured with a float actuated pilot valve where the float is resting on the surface of the water within the standpipe.

These system are complex and include numerous component such as a standpipe, a main flow control valve, a control system configure to regulate the operation of the main flow control valve and a float mechanism to actuate the control system.

There is therefore a need for a standpipe float valve in which the float mechanism directly actuates a valve plug that is deployed within the standpipe.

### SUMMARY OF THE INVENTION

The present invention is a standpipe float valve in which the float mechanism directly actuates a valve that is deployed within the standpipe

According to the teachings of the present invention there is provided. A standpipe float valve comprising: a) a standpipe housing having an inlet port and an outlet port; b) a valve plug deployed within the standpipe housing, the valve plug configured to regulate a flow of fluid into the standpipe housing; and c) a float element deployed within the standpipe housing and reactive to a fluid level in the standpipe housing, the float element attached to the valve plug and configured to actuate the valve plug.

The standpipe float valve of claim 1, wherein the float element is configured to directly actuate the valve plug.

According to a further teaching of the present invention, the valve plug is directly connected to the float element.

According to a further teaching of the present invention, the valve plug and the float element are integrally formed.

According to a further teaching of the present invention, at least a portion of a valve mechanism is integrally formed with the standpipe housing.

According to a further teaching of the present invention, the standpipe housing has a substantially cylindrical interior volume, the valve plug has a substantially cylindrical outer face and an outside diameter of the valve plug is substantially equal to an inside diameter of the cylindrical interior volume of the standpipe housing such that the valve plug is slidingly displaceable within the standpipe housing between an open position, in which fluid flows through the inlet port into the standpipe housing and a closed position in which fluid flow through the inlet valve is blocked.

According to a further teaching of the present invention, the inlet port is configured in a sidewall of the standpipe housing and the valve plug directly blocks the inlet valve when the valve plug is in the closed position.

According to a further teaching of the present invention, the outlet port is configured in a sidewall of the standpipe housing and the valve plug is configured so as not to block the outlet valve.

According to a further teaching of the present invention, the valve plug is substantially flat with first and second substantially planar valve plug faces, the first and second valve plug faces being substantially parallel, and the valve plug being vertically displaceable within the standpipe housing between an open position, in which fluid flows through the inlet port into the standpipe housing and a closed position in which fluid flow through the inlet port is blocked.

According to a further teaching of the present invention, the valve plug directly blocks the inlet port when the valve plug is in the closed position.

The standpipe float valve of claim 9, the inlet port and the outlet port extend into an interior volume of the standpipe housing so as to be linearly opposed with the valve plug deployed in a space separating valve faces configured in each of the inlet port and the outlet port such that the valve face of the inlet port is adjacent to the first valve plug face and the valve face of the outlet port is adjacent to the second valve plug face, and the outlet port includes at least one opening configured to provide fluid flow between the interior volume of the standpipe housing and the outlet port.

According to a further teaching of the present invention, there is also provided friction reducing elements deployed between the outlet port and the second valve plug face.

According to a further teaching of the present invention, the first and second valve plug faces are substantially parallel to a direction of displacement of the valve plug.

According to a further teaching of the present invention, there is also provided a standpipe housing cap that includes a support guide configured to retain a support element extending from the float element.

There is also provided according to the teachings of the present invention, a method for maintaining a substantially constant flow pressure through an outlet port of a standpipe float valve having a standpipe housing configured with an inlet port and an outlet port, the method comprising: a) providing a valve plug deployed within the standpipe housing, the valve plug configured regulate a flow of fluid into the standpipe housing, and a float element deployed within the standpipe housing and reactive to a fluid level in the standpipe housing, the float element attached to the valve plug and configured to actuate the valve plug; b) provide a flow of fluid to the inlet port; and c) maintain a substantially constant fluid level in the standpipe housing by displacement of the float element in response to a fluid level in the standpipe housing so as to actuate the valve plug between an open position, in which fluid flows through the inlet port into the standpipe housing and a closed position in which fluid flow through the inlet port is blocked.

According to a further teaching of the present invention, there is also provided directly connecting the valve plug to the float element.

According to a further teaching of the present invention, the valve plug and the float element are implemented as an integrally formed component.

According to a further teaching of the present invention, there is also provided directly blocking the inlet port directly with the valve plug when the valve plug is in the closed position.

### BRIEF DESCRIPTION OF THE DRAWINGS

The invention is herein described, by way of example only, with reference to the accompanying drawings, wherein:

FIG. 1 is a transparent perspective view of a first variant of a first preferred embodiment of a standpipe direct float valve constructed and operational according to the teachings of the present invention, shown here with a cylindrical valve plug;

FIG. 2 is a transparent perspective view of a second variant of the first preferred embodiment of a standpipe direct float valve constructed and operational according to the teachings of the present invention, shown here with a cylindrical valve plug that is configured so as not to block the outlet port;

FIG. 3 is a perspective vertical section view of the embodiment of FIG. 2;

FIG. 4 is a detail of the of FIG. 3;

FIG. 5 is a perspective vertical section view of a first variant of a second preferred embodiment of a standpipe direct float valve constructed and operational according to the teachings of the present invention, shown here with a planar valve plug;

FIG. 6 is a detail of the embodiment of FIG. 5;

FIG. 7 is a perspective vertical section view of a second variant of the second preferred embodiment of a standpipe direct float valve constructed and operational according to the teachings of the present invention; and

FIG. 8 is a sectional detail of the embodiment of FIG. 7.

### DESCRIPTION OF THE PREFERRED EMBODIMENTS

The present invention is a standpipe float valve in which the float mechanism directly actuates a valve plug that is deployed within the standpipe

The principles and operation of standpipe float valve according to the present invention may be better understood with reference to the drawings and the accompanying description.

By way of introduction, the standpipe direct float valve of the present invention is configured such that the valve plug is directly connected to the float element and both the valve plug and the float element are deployed within the standpipe housing.

In the preferred embodiments described herein, the standpipe housing has an inlet port and at least one outlet port. The valve plug is configured to regulate the fluid level, commonly referred to in the art as head, in the standpipe housing by controlling the flow of fluid through the inlet port and into the standpipe housing. The valve plug is deployed within the standpipe housing and is directly connected to, and actuated by, a float element that is also deployed within the standpipe housing and reactive to the fluid level in the standpipe housing. Preferably, as illustrated herein, the valve plug and the float element are integrally formed.

So configured, the standpipe float valve of the present invention provides a method for maintaining a substantially constant flow pressure through an outlet port of a standpipe float valve having a standpipe housing configured with an inlet port and an outlet port.

This is accomplished by maintaining a substantially constant fluid level into the standpipe housing by displacement of the float element in response to the fluid level in the standpipe housing so as to actuate the valve plug between an open position, in which fluid flows through the inlet port into the standpipe housing and a closed position in which fluid flow through the inlet port is blocked. It should be noted that, a full range of fluid flow through the inlet port and into the standpipe housing is possible since a full range of movement of the valve plug between the fully closed position and the fully open position is possible.

As is known in the art, under normal operating circumstances, the standpipe float valve of the present invention maintains equilibrium between the fluid flowing into the standpipe housing through the inlet port and the fluid flowing out of the standpipe housing through the outlet port. If the outlet port's demand decreases, or the inlet port's flow increases, the fluid level in the standpipe housing rises bringing the float element with it, which in turn causes the valve plug to throttle the standpipe float valve to closed, thereby decreasing the fluid flow into the standpipe housing in an attempt to regain equilibrium. Conversely, if the outlet port's demand increases, the fluid level in the standpipe housing lowers bringing the float element with it, which in turn causes the valve plug to throttle the standpipe float valve to open, thereby increasing the fluid flow into the standpipe housing in an attempt to regain equilibrium.

The features of novelty of the standpipe float valve of the present invention include an integrally form valve plug and float element and at least some of the components of the valve mechanism are integrally form with the standpipe housing.

Two preferred embodiments of the standpipe float valve of the present invention will be discussed herein as non-limiting examples of the principles of the present invention.

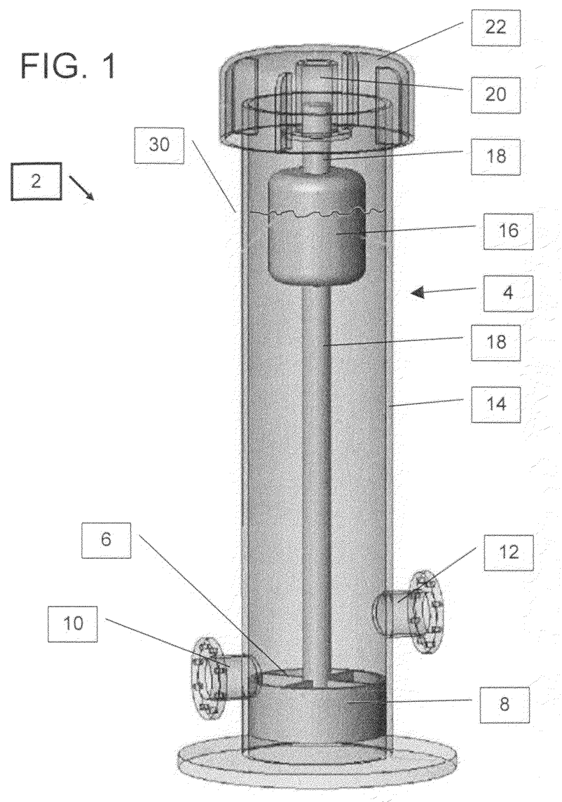

Referring now to the drawings, FIG. 1 illustrates a first variant of a first preferred embodiment of the standpipe float valve of the present invention generally referred to as 2. As shown here, the standpipe housing 4 has a substantially cylindrical interior volume with an inlet port 10 and an outlet port 12 configured in the cylindrical side wall 14 of the standpipe housing 4. The valve plug 6 has a substantially cylindrical outer face 8 whose outside diameter is substantially equal to an inside diameter of the cylindrical interior volume of the standpipe housing 4 such that the valve pig 6 is slidingly displaceable within the standpipe housing between an open position, in which fluid flows through the inlet port 10 into the standpipe housing 4 and a closed position in which fluid flow through the inlet port 10 is blocked. As illustrated here, valve plug 6 directly blocks inlet port 10 when valve plug 6 is in the closed position. Notice that inlet port 10 and outlet port 12 are vertically offset in order that the valve plug 6 does not block the outlet port.

The valve plug 6 maintains equilibrium between the fluid flowing into the standpipe housing 4 through the inlet port 10 and the fluid flowing out of the standpipe housing 4 through the outlet port 12. The valve plug 6 is actuated by the float element 16 which is deployed within said standpipe housing 4 and reactive to a fluid level 30 in the standpipe housing 4. It is a principle of the present invention that the float element 16 be directly attached to the valve plug 4 and as shown here, preferably integrally formed with the valve plug 4. To that end, valve plug 6 and float element 16 are interconnected by, and preferably integrally formed with, valve actuating shaft 18. In order to provide lateral stability to the upper end of valve actuating shaft 18 it is configured to extend above the float element 16 and slidingly engage the support guide 20 configured in the standpipe cover 22. It will be readily understood that such lateral stability may be achieved by any number of various configurations and that the support guide arrangement illustrated herein is to be considered only as a non-limiting example. It will be appreciated that float element may be configured as a separate element slidingly deployed on valve actuating shaft 18 such that the head, i.e., the fluid level, in the standpipe housing may be adjusted as desired and that such embodiments are within the scope of the present invention.

The standpipe float valve 2 is illustrated here with the valve plug 6 partially blocking the inlet port 10 so as to maintain equilibrium between the fluid flowing into the standpipe housing 4 through the inlet port 10 and the fluid flowing out of the standpipe housing through the outlet port 12. It will be appreciated that should the outlet port flow demand increase and the fluid level 30 fall, so too will valve plug 6, thereby increasing the open area of the inlet port 10, which will in turn increase the fluid flow into the standpipe housing in order to meet the increased fluid flow demand. Likewise, should the inlet port flow demand decrease, or the inlet flow increase, and the fluid level 30 rise, so too will valve plug 6, thereby decreasing the open area of the inlet port 10, which will in turn decrease the fluid flow into the standpipe housing in order to accommodate the change in fluid flow demand. It will be appreciated that once the change in fluid flow has been accommodated a new equilibrium will be achieved.

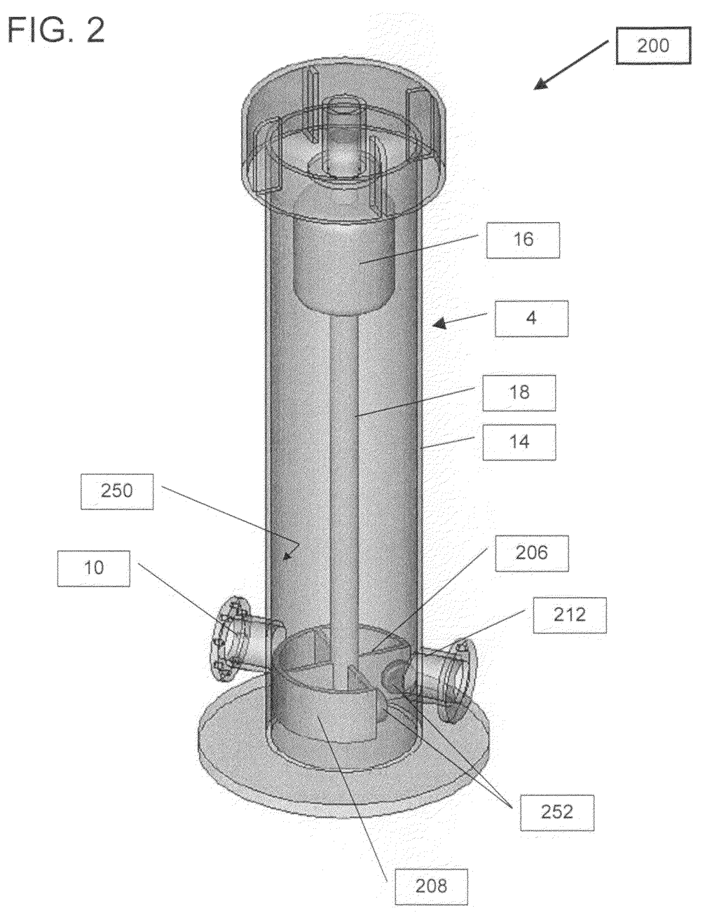

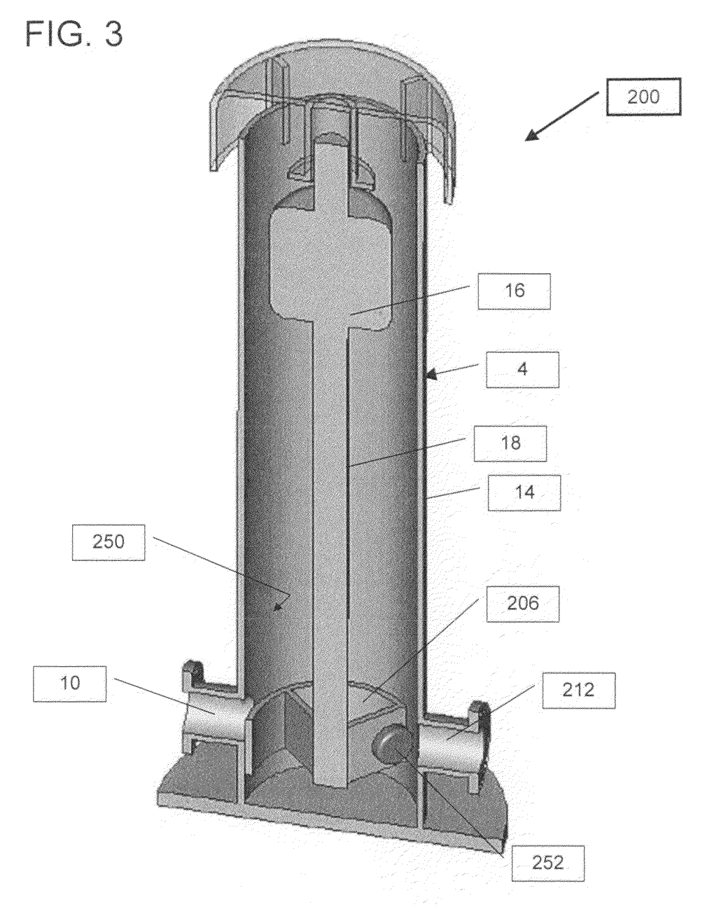

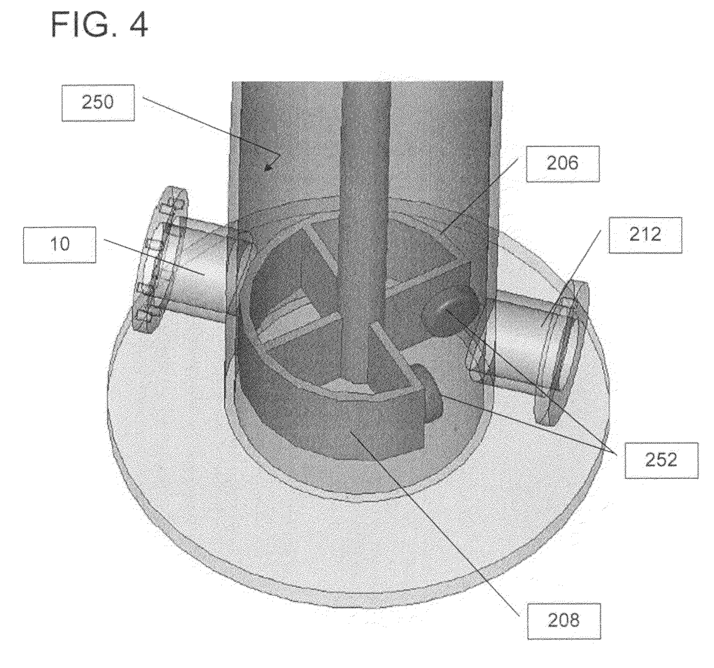

FIGS. 2-4 illustrate a second variant of the first preferred embodiment of the standpipe float valve of the present invention generally referred to as 200. The operation and components of this variant are identical to the components of the first variant illustrated in FIG. 1, with the exception of the location of the outlet port 212 and the configuration of the valve plug 206. Therefore, similar components are numbered alike and the description is focused on variant features.

In this variant, outlet port 212 is configured in the cylindrical side wall 14 of the standpipe housing 4 so as to be vertically aligned with the inlet port 10. It should be noted that although illustrated as linearly opposed, this is not intended as a limitation but rather for ease of illustration. It will be appreciated that the angular relationship between the inlet port 10 and the outlet port 212 may be substantially any suitable angle.

With the inlet port 10 and the outlet port 212 vertically aligned, it is necessary to configure the valve plug 206 so as to not block the outlet port 212. To that end, the semi-circumferential outer wall 208 of valve plug 206 extends only partially about the circumference of the valve plug 206. Therefore, there is no circumferential outer wall 208 in the region adjacent to the outlet port 212. In order to provide stability for valve 206 and maintain abutment of the outer surface of outer wall 208 with the inside surface 250 of the standpipe housing 4, especially in the region of inlet port 10, valve plug 206 is configured with at least two wheel elements 252 that rotate during displacement of valve plug 206. Each of the wheel elements 252 is deployed on valve plug 206 at opposite ends of outer wall 208 and extends from valve plug 206 outwardly so as to contact the inside surface 250 of the standpipe housing 4. It will be appreciated that embodiments in which wheel elements 252 are replaced by non-rotating stabilizing elements and the contact between the inside surface 250 of the standpipe housing 4 and the contact surface of the stabilizing elements provides low friction is within the scope of the present invention.

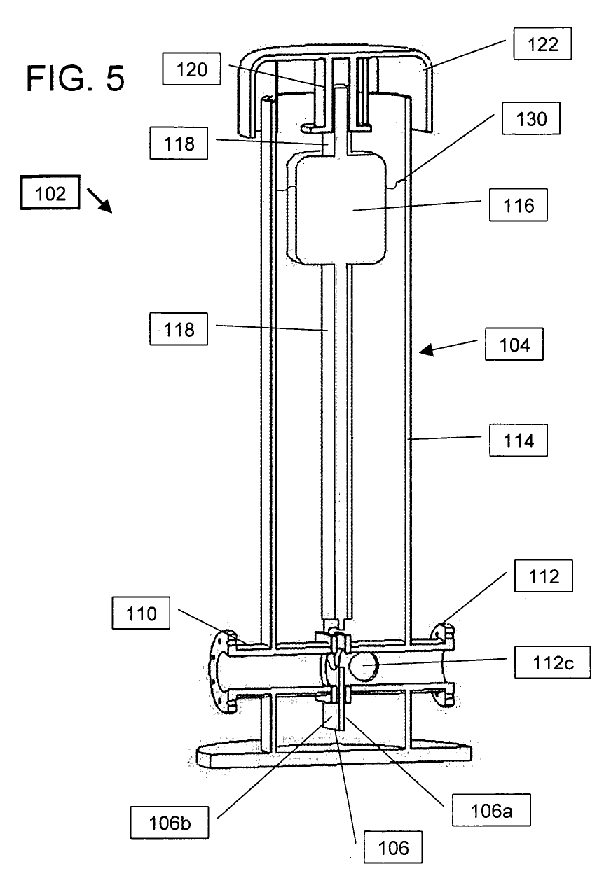

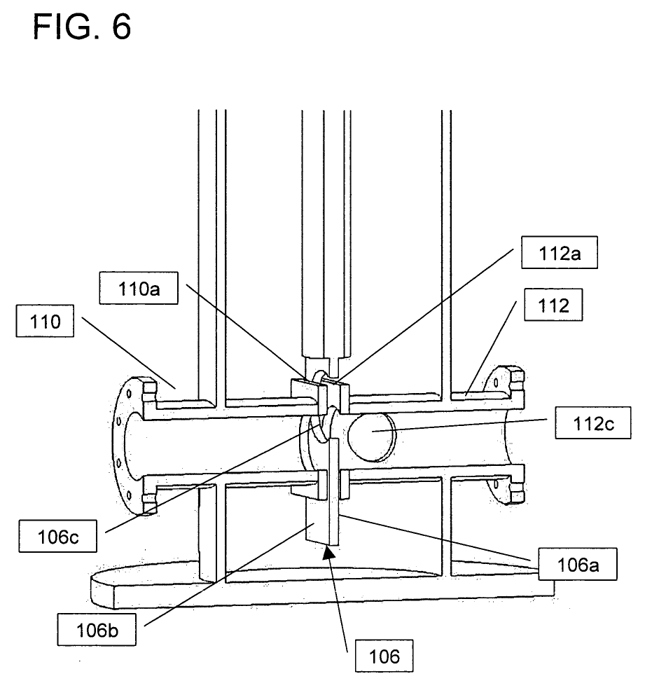

Turning now to FIGS. 5 and 6 which illustrate a first variant of a second preferred embodiment of the standpipe float valve of the present invention generally referred to as 102. As shown here, the standpipe float valve 102 has a standpipe housing 104 configured with an inlet port 110 that extends inwardly from the side wall 114 of the standpipe housing 104. An inlet port 112 is configured in the side wall 114 of standpipe housing 104 opposite the inlet port 110. In this non-limiting illustration, the inlet port 110 and the outlet port 112 extend into the interior volume of the standpipe housing 104 so as to be linearly opposed one to another. The valve plug 106 is substantially flat and configured with first and second substantially planar valve plug faces 106a and 106b, which are substantially parallel one to another as well as parallel to a direction of displacement of the valve plug 106. The valve plug 106 is vertically displaceable within the standpipe housing between an open position, in which fluid flows through the inlet port 110 and a closed position in which fluid flow through the inlet port 110 is blocked. As illustrated here, valve plug 106 directly blocks inlet port 110 when valve plug 106 is in the closed position.

Thusly configured, valve plug 106 is deployed in the space separating valve faces 110a and 112a such that the valve face 110a of the inlet port 110 is adjacent to valve plug face 106b and the valve face 112a of outlet port 112 is adjacent to valve plug face 106a. The outlet port 112 includes at least one opening 112a configured to provide fluid flow between the interior volume of the standpipe housing 104 and the outlet port 112.

As in embodiment 2, the valve plug 106 maintains equilibrium between the fluid flowing into the standpipe housing 104 through the inlet port 110 and the fluid flowing out of the standpipe housing 104 through the outlet port 112. The valve plug 106 is actuated by the float element 116 which is deployed within said standpipe housing 104 and reactive to a fluid level 130 in the standpipe housing 104. Valve plug 106 and float element 116 are interconnected by, and preferably integrally formed with, valve actuating shaft 118. In order to provide lateral stability to the upper end of valve actuating shaft 118 it is configured to extend above the float element 116 and slidingly engage the support guide 120 configured in the standpipe cover 122. It will be readily understood, here too, that such lateral stability may be achieved by any number of various configurations and that the support guide arrangement illustrated herein is to be considered only as a non-limiting example.

The standpipe float valve 102 is illustrated here with the valve plug 106 partially blocking the inlet port 110, thereby allowing fluid to pass through only a portion of opening 106c so as to maintain equilibrium between the fluid flowing into the standpipe housing 104 through the inlet port 110 and the fluid flowing out of the standpipe housing through the outlet port 112. As in embodiment 2 above, it will be appreciated that should the outlet port flow demand increase and the fluid level 130 fall, so too will valve plug 106, thereby increasing the open area of opening 106c deployed between valve faces 110a and 112a, which will in turn increase the fluid flow through outlet port 112 and, once the increased fluid flow demand is met, into the standpipe housing 104 through opening 112c. Likewise, should the inlet port flow demand decrease, or the inlet flow increase, and the fluid level 130 rise, so too will valve plug 106, thereby decreasing the open area of opening 106c deployed between valve faces 110a and 112a, which will in turn decrease the fluid flow through outlet port 112 and into the standpipe housing 104 through opening 112c. It will be appreciated that once the change in fluid flow has been accommodated a new equilibrium will be achieved.

It should be noted that the inlet port and the outlet port need not be linearly opposed one to another, nor do the valve plug face need to be parallel, and that embodiments in which the inlet port and outlet port and angularly opposed and the valve plug faces are configured at angles so as to align with the inlet and outlet ports are within the scope of the present invention.

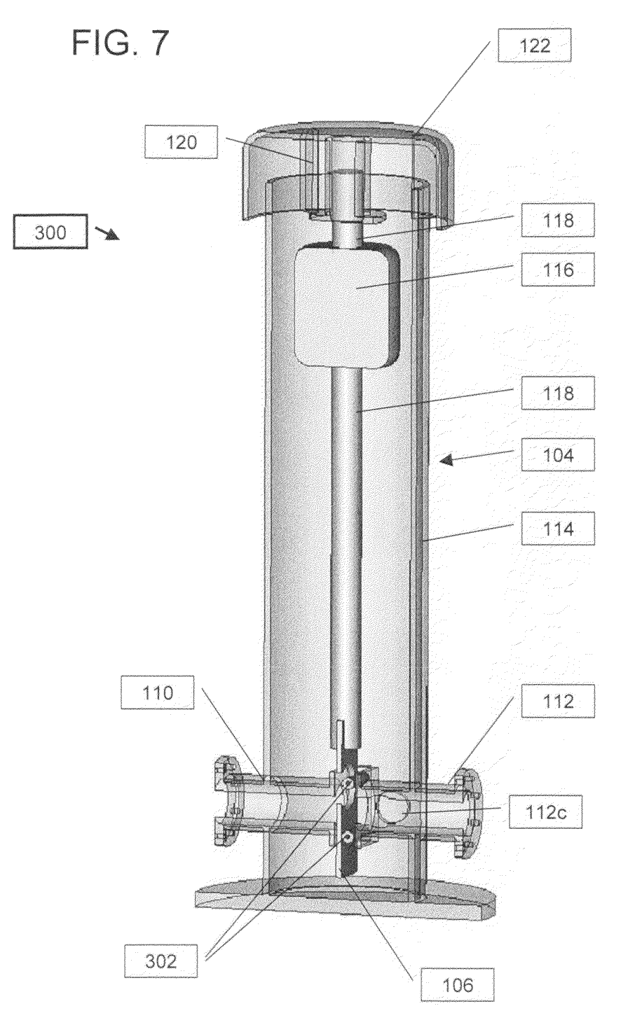

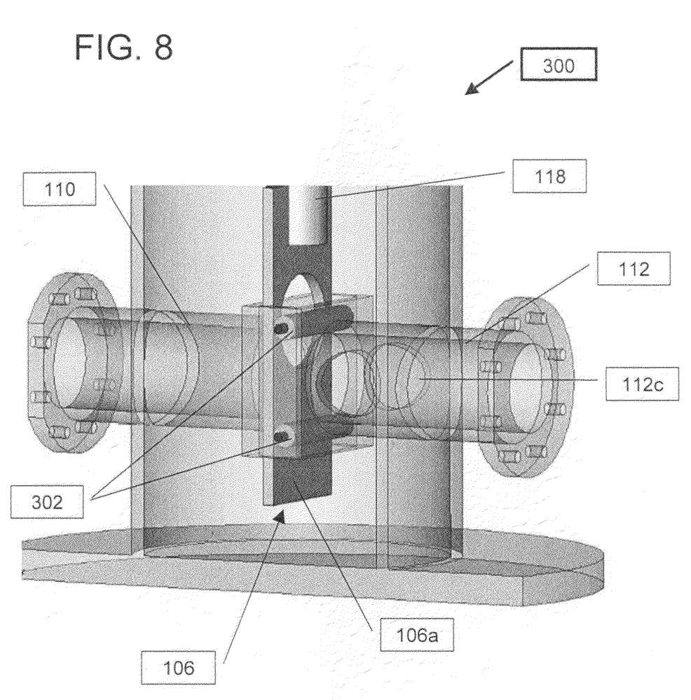

FIGS. 7 and 8 illustrate a second variant of the second preferred embodiment of the standpipe float valve of the present invention generally referred to as 300. The operation and components of this variant are identical to the components of the first variant illustrated in FIGS. 5 and 6, with the exception of the additional rollers 302. Therefore, similar components are numbered alike and the description is focused on variant features.

Due to the force of fluid flowing through the inlet port 110, friction between valve plug face 106a and valve face 112a may interfere with the smooth displacement of the valve plug 106. In order to reduce such friction, friction reducing elements are deployed between valve plug face 106a and valve face 112a. In the non-limiting illustrations herein, the friction reducing elements are rollers 302 are deployed between valve plug face 106a and valve face 112a such that valve plug face 106a contacts the rollers 302 rather than having direct contact with valve face 112a as in the first variant of FIGS. 5 and 6.

It will be readily appreciated that embodiments in which rollers 302 are replaced by other friction reducing elements such as, but not limited to, wheels or non-rotating elements configured from, or coated with, low friction materials, such as but not limited to nylon and Teflon® are within the scope of the present invention.

It will be appreciated that the above descriptions are intended only to serve as examples and that many other embodiments are possible within the spirit and the scope of the present invention.

What is claimed is:

1. A standpipe float valve comprising:
(a) a standpipe housing having an inlet port and an outlet port;
(b) a valve plug deployed within said standpipe housing, said valve plug configured to regulate a flow of fluid into said standpipe housing; and
(c) a float element deployed within said standpipe housing and reactive to a fluid level in said standpipe housing, said float element attached to said valve plug and configured to actuate said valve plug.

2. The standpipe float valve of claim 1, wherein said float element is configured to directly actuate said valve plug.

3. The standpipe float valve of claim 1, wherein said valve plug is directly connected to said float element.

4. The standpipe float valve of claim 2, wherein said valve plug and said float element are integrally formed.

5. The standpipe float valve of claim 1, wherein at least a portion of a valve mechanism is integrally formed with said standpipe housing.

6. The standpipe float valve of claim 1, wherein said standpipe housing has a substantially cylindrical interior volume, said valve plug has a substantially cylindrical outer face and an outside diameter of said valve plug is substantially equal to an inside diameter of said cylindrical interior volume of said standpipe housing such that said valve plug is slidingly displaceable within said standpipe housing between an open position, in which fluid flows through said inlet port into said standpipe housing and a closed position in which fluid flow through said inlet valve is blocked.

7. The standpipe float valve of claim 6, wherein said inlet port is configured in a sidewall of said standpipe housing and said valve plug directly blocks said inlet valve when said valve plug is in said closed position.

8. The standpipe float valve of claim 7, wherein said outlet port is configured in a sidewall of said standpipe housing and said valve plug is configured so as not to block said outlet valve.

9. The standpipe float valve of claim 1, wherein said valve plug is substantially flat with first and second substantially planar valve plug faces, said first and second valve plug faces being substantially parallel, and said valve plug being vertically displaceable within said standpipe housing between an open position, in which fluid flows through said inlet port into said standpipe housing and a closed position in which fluid flow through said inlet port is blocked.

10. The standpipe float valve of claim 9, wherein said valve plug directly blocks said inlet port when said valve plug is in said closed position.

11. The standpipe float valve of claim 9, said inlet port and said outlet port extend into an interior volume of said standpipe housing so as to be linearly opposed with said valve plug deployed in a space separating valve faces configured in each of said inlet port and said outlet port such that said valve face of said inlet port is adjacent to said first valve plug face and said valve face of said outlet port is adjacent to said second valve plug face, and said outlet port includes at least one opening configured to provide fluid flow between said interior volume of said standpipe housing and said outlet port.

12. The standpipe float valve of claim 11, further including friction reducing elements deployed between said outlet port and said second valve plug face.

13. The standpipe float valve of claim 9, wherein said first and second valve plug faces are substantially parallel to a direction of displacement of said valve plug.

14. The standpipe float valve of claim 1, further including a standpipe housing cap that includes a support guide configured to retain a support element extending from said float element.

15. A method for maintaining a substantially constant flow pressure through an outlet port of a standpipe float valve having a standpipe housing configured with an inlet port and an outlet port, the method comprising:
(a) providing a valve plug deployed within said standpipe housing, said valve plug configured regulate a flow of fluid into said standpipe housing, and a float element deployed within said standpipe housing and reactive to a fluid level in said standpipe housing, said float element attached to said valve plug and configured to actuate said valve plug;
(b) provide a flow of fluid to said inlet port; and
(c) maintain a substantially constant fluid level in said standpipe housing by displacement of said float element in response to a fluid level in said standpipe housing so as to actuate said valve plug between an open position, in which fluid flows through said inlet port into said standpipe housing and a closed position in which fluid flow through said inlet port is blocked.

16. The method of claim 15, further including directly connecting said valve plug to said float element.

17. The method of claim 16, wherein said valve plug and said float element are implemented as an integrally formed component.

18. The method of claim 15, further including directly blocking said inlet port directly with said valve plug when said valve plug is in said closed position.
